(19) United States
(12) Patent Application Publication
(10) Pub. No.: US 2015/0355798 A1
(43) Pub. Date: Dec. 10, 2015

(54) DOCUMENT READER, DOCUMENT PAGE TURN OVER METHOD AND PROGRAM

(71) Applicant: NEC CASIO MOBILE COMMUNICATIONS, LTD., Kanagawa (JP)

(72) Inventor: Hidetoshi KINEHARA, Kawasaki-shi, Kanagawa (JP)

(73) Assignee: NEC CORPORATION, Tokyo (JP)

(21) Appl. No.: 14/762,334

(22) PCT Filed: Jan. 31, 2014
(86) PCT No.: PCT/JP2014/052229

§ 371 Date: Jul. 21, 2015

(30) Foreign Application Priority Data
Jan. 31, 2013 (JP) 2013-016849

(51) Int. Cl. G06F 3/0483; G06F 3/0484

(52) U.S. Cl. CPC G06F 3/0483; G06F 3/04845

(57) ABSTRACT

A document reader includes a display unit demonstrates a region representing contents of a page selected by a user of an electronic document of a style composed by a plurality of pages held together and a region which is provided neighboring to the region representing the page contents and which represents the thickness of a plurality of pages held together. The document reader also includes an action detection unit that detects contents of an action on the electronic document performed by specifying an arbitrary point in each of the regions, and a display control unit. In case an action of specifying two points, namely an arbitrary position in the region representing the page contents and an arbitrary position in the region representing the thickness of the pages held together, is carried out by a user so that the two points are specified in succession, the display control unit performs a processing of turning over pages up to a page corresponding to the position specified in the region representing the thickness of the pages held together.

### CROSS-REFERENCE TO RELATED APPLICATIONS

The present application is a National Stage Entry of PCT/JP2014/052229 filed Jan. 31, 2014, which is based on and claims the benefit of the priority of Japanese Patent Application No. 2013-016849, filed on Jan. 31, 2013, the disclosures of all of which are incorporated herein in their entirety by reference.

### TECHNICAL FIELD

This invention relates to a reader for an electronic document, a page turn over method for the electronic document, and a program. More particularly, it relates to a document reader for an electronic document of a style comprising a plurality of pages folded and bound together, a page turn over method for the electronic document, and a program.

### BACKGROUND

Recently, smartphones or tablet terminals, fitted with touch panels, have come into widespread use. Also, electronic documents, such as electronic books or electronic operation manuals, are presented for use with these devices, with which it is possible to turn over pages of the electronic document with the sense or feel similar to that with paper books.

In addition, a variety of proposals have been made to enhance the operability in reading the electronic documents. Patent Literature 1 shows a mobile terminal including a touch panel with which a plurality of points can be simultaneously detected to permit execution of a plurality of different operations. For example, in claim 2, paragraph 0037 and FIG. 5 of Patent Literature 1, it is stated that, if a user performs a flick action with his/her N fingers on a screen representing a page of the electronic document, N pages can be turned over. By the flick action, also called a slip or slide action, is meant the manual operation by a user of slipping or sliding his/her N fingers in one direction, as he/she keeps his/her fingers contacted with the screen surface, so as to turn over N pages.

Patent Literature 2 also shows a mobile information device in which, if a user keeps on touching an image simulating a ‘thickness of a book’, it is possible to turn over pages in succession with a sense of actually turning over multiple pages of a real paper book in succession (paragraph 0082). It is also stated that, in this mobile information device, the page turn over speed can be varied by the user changing his/her screen touching pressure.

### Patent Literatures

### PATENT LITERATURE 1: JP Patent Kokai Publication No. 2011-170603A

### PATENT LITERATURE 2: JP Patent Kokai Publication No. 2000-163444A

### SUMMARY

The following analysis is made by the present invention. If, in the mobile terminal, shown in the above mentioned Patent Literature 1, it is attempted to read a specific page of an electronic document, containing many pages, the target page cannot be reached unless a number of flick actions are performed.

In the method shown in Patent Literature 2, it is possible to turn over pages speedily by a user strongly touching the portion of the image simulating the ‘thickness of the book’. However, this method suffers a problem that, if the book contains many pages, the user is kept waiting for a long time until the target page is displayed.

The above mentioned problems may arise not only with a small-sized terminal, such as a smartphone or a tablet terminal, but also with a personal computer, in case of reading an electronic book containing many pages.

It is an object of the present invention to provide a document reader having an interface convenient in reading an electronic document containing a number of pages, in particular an extremely large number of pages, a method for turning over the pages of the electronic document, and a program.

In one aspect, there is provided a document reader comprising a display unit that demonstrates a region representing contents of a page selected by a user of an electronic document of a style composed by a plurality of pages held together and a region which is provided neighboring to the region representing the page contents and which represents the thickness of the plurality of the pages held together, an action detection unit that detects contents of an action on the electronic document performed by specifying an arbitrary point in each of the above mentioned regions, and a display control unit that performs a processing of turning over multiple pages in case of carrying out an action of specifying two points, namely an arbitrary position in the region representing the page contents and an arbitrary position in the region representing the thickness of the plurality of the pages held together, so that the two points are specified in succession. The processing of turning over multiple pages is performed up to a page corresponding to the position specified in the region representing the thickness of the plurality of the pages held together.

In a second aspect, there is provided a method for turning over multiple pages of an electronic document of a style composed by a plurality of pages held together, in a document reader including a display unit that displays a region representing contents of a page of the electronic document selected by a user and a region which is provided neighboring to the region representing the page contents and which represents the thickness of the plurality of the pages held together, in which the method comprises: detecting contents of actions performed on the electronic document by specifying at least two points, and performing a processing of turning over multiple pages in case of carrying out an action of specifying two points, namely an arbitrary position in the region representing the page contents and an arbitrary position in the region representing the thickness of the plurality of the pages held together. The processing of turning over multiple pages is performed up to a page corresponding to the position specified in the region representing the thickness of the plurality of the pages held together. The present method is tied up to a particular machine which is a document reader for demonstrating an electronic document composed by a plurality of folded pages held together.

In a third aspect, there is provided a non-transitory computer-readable recording medium storing thereon a program for causing a computer provided onboard a document reader including a display unit that displays a region representing contents of a page selected by a user of an electronic document of a style composed by a plurality of pages held together and a region which is provided neighboring to the region representing the page contents and which represents the thickness of the plurality of the pages held together, to perform a processing for: detecting contents of an action performed on the electronic document by specifying at least two points, and a processing of performing a processing of turning over multiple pages in case of carrying out an action of specifying two points, namely an arbitrary position in the region representing the page contents and an arbitrary position in the region representing the thickness of the plurality of the pages held together. The processing of turning over multiple pages is performed up to a page corresponding to the position specified in the region representing the thickness of the plurality of the pages held together. The present program can be recorded on a computer readable, that is, non-transient, recording medium. That is, the present invention can be implemented as a computer program product.

The meritorious effects of the present invention are summarized as follows.

According to the present invention, there may be provided an operation interface convenient for reading an electronic document composed by a larger number of pages. That means that the present invention transforms the conventional document reader described as prior art into an innovative document reader that having improved interface for reading an electronic document composed by a larger number of pages.

### BRIEF DESCRIPTION OF THE DRAWINGS

FIG. 1 is a perspective view showing an appearance of a document reader according to an exemplary embodiment 1 of the present disclosure.

FIG. 2 is a functional block diagram, partly shown in a front view, showing the document reader according to the exemplary embodiment 1 of the present disclosure.

FIG. 3 is a front view showing an example of a display screen of the document reader according to the exemplary embodiment 1 of the present disclosure.

FIG. 4 is a flowchart showing the flow of a first style page turn over operation of the document reader according to the exemplary embodiment 1 of the present disclosure.

FIG. 5(a), FIG. 5(b) and FIG. 5(c) are front views showing the operation flow corresponding to the flowchart shown in FIG. 4.

FIG. 6 is a flowchart showing the flow of a second style page turn over operation of the document reader according to the exemplary embodiment 1 of the present disclosure.

FIG. 7(a), FIG. 7(b) and FIG. 7(c) are front views showing the operation flow corresponding to the flowchart shown in FIG. 6.

FIG. 8 is a functional block diagram, partly shown in a front view, showing a document reader according to an exemplary embodiment 2 of the present disclosure.

FIG. 9 is a flowchart showing a page turn over operation of the document reader according to the exemplary embodiment 2 of the present disclosure.

FIG. 10(a) is a perspective view and FIG. 10(b), FIG. 10(c) are front views, showing the operation flow corresponding to the flowchart shown in FIG. 9.

FIG. 11 is a front view showing another example of the display screen of the document reader according to the present disclosure.

FIG. 12 is a front view showing still another example of the display screen of the document reader according to the present disclosure.

### PREFERRED MODES

A preferred mode of the present disclosure will now be summarized with reference to the drawings. It should be noted that symbols are entered in the summary merely as examples to assist in understanding and are not intended to limit the present disclosure to the mode illustrated.

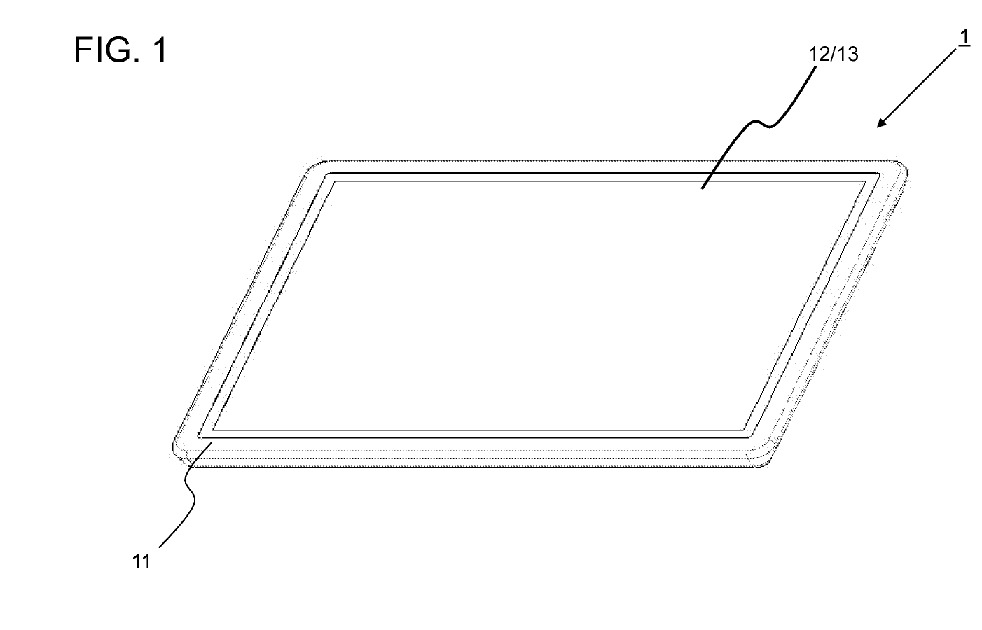

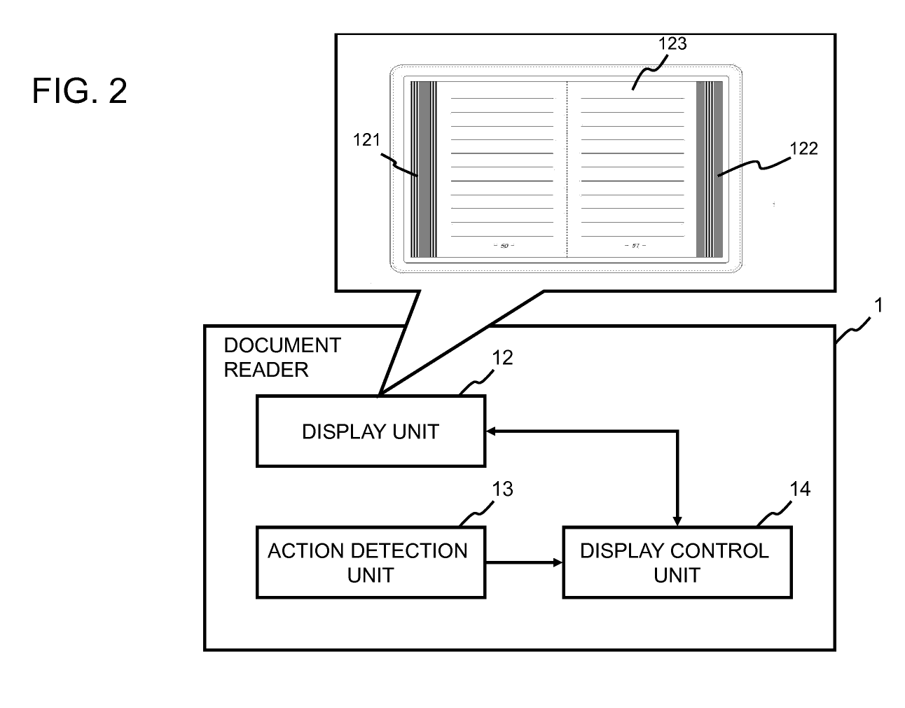

In a preferred mode, the present disclosure may be implemented by a configuration shown in FIG. 1 and FIG. 2, including a display unit (12 of FIG. 2), an action detection unit (13 of FIG. 2), and a display control unit (14 of FIG. 2). The display unit includes a region (123 of FIG. 2) representing the contents of a page(s) selected by a user of an electronic document of a style composed by a plurality of folded pages held together, and regions (121, 122 of FIG. 2) provided neighboring to the region representing the page contents to represent the thickness of the plurality of the folded pages. The action detection unit detects the contents of actions on the electronic document performed by specifying or pointing to at least two points. The display control unit performs, in case a user has performed an action of specifying two points, namely an arbitrary position in the region representing the page contents and an arbitrary position in the region representing the thickness of the folded pages, an operation of turning over multiple pages up to a page corresponding to the specified position in the region representing the thickness of the folded pages.

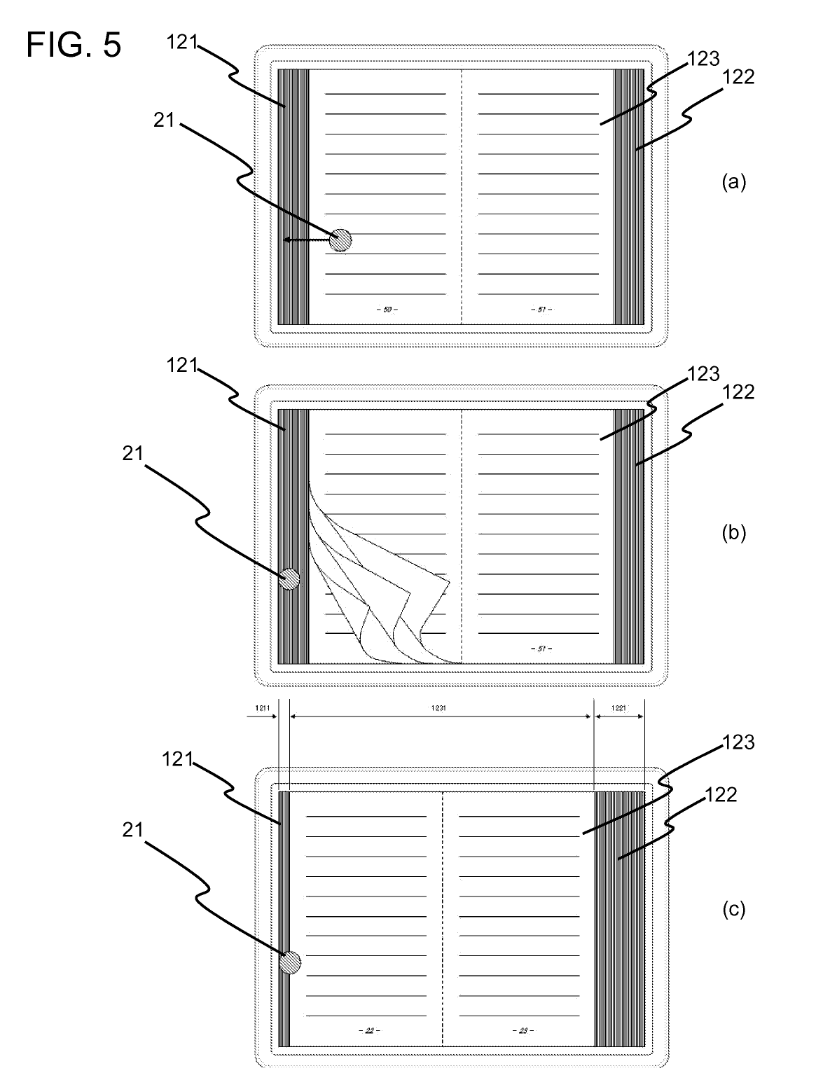

If, for example, the user has performed an action of pointing to an arbitrary position in the region representing the thickness of folded pages (121 of FIG. 2) and subsequently pointing to an arbitrary position in the region representing the page contents (123 in FIG. 2), the document reader performs an operation of skipping over intermediate pages to represent the page corresponding to the specified position in the region representing the thickness of folded pages, as shown in FIG. 5(a) to FIG. 5(c).

There is thus provided an operation interface performing an operation proximate to the action of turning over multiple pages of a real paper book.

### Exemplary Embodiment 1

An exemplary embodiment 1, in which the present disclosure is applied to a tablet terminal including a touch panel, will now be described in detail with reference to the drawings. FIG. 1 depicts a perspective view showing a document reader according to an exemplary embodiment 1 of the present disclosure. Referring to FIG. 1, there is shown a document reader 1 which is comprised of a housing 11 of a thin thickness and a display mounted on a front surface of the housing and which is provided with a touch panel configured to operate as a display unit 12 and as an action detection unit 13.

FIG. 2 depicts a functional block diagram of the document reader 1 shown in FIG. 1. Referring to FIG. 2, there is shown a configuration including the display unit 12, action detection unit 13 and the display control unit 14.

Referring to FIG. 1, the display unit 12 is formed by e.g., a liquid crystal display device, an organic electroluminescence display device (organic EL display device) etc.

The action detection unit 13 is formed by a touch sensor and a digitizer which are arranged so as to overlap with the liquid crystal display device or the organic EL display device making up the display unit 12. The contents of actions on an electronic document, detected by the action detection unit 13 during the time the electronic document is demonstrated on the display unit 12, are entered to the display control unit 14.

When so requested by a user, the display control unit 14 reads out the electronic document of a style comprised of a plurality of pages folded and bound together, and displays the so read out electronic document on the display unit 12. It should be noted that the electronic document represented may be an electronic document stored in a memory of a main body part of the document reader 1 or an electronic document received from a server etc. provided on a network via any of a variety of communication unit provided on the document reader 1.

By the way, the display control unit 14 of the document reader 1, shown in FIG. 2, may be implemented by a computer program that causes a computer onboard the document reader 1 to execute the processing by the display control unit 14 using the computer's hardware resources. The processing by the display control unit 14 will be described herein later in detail.

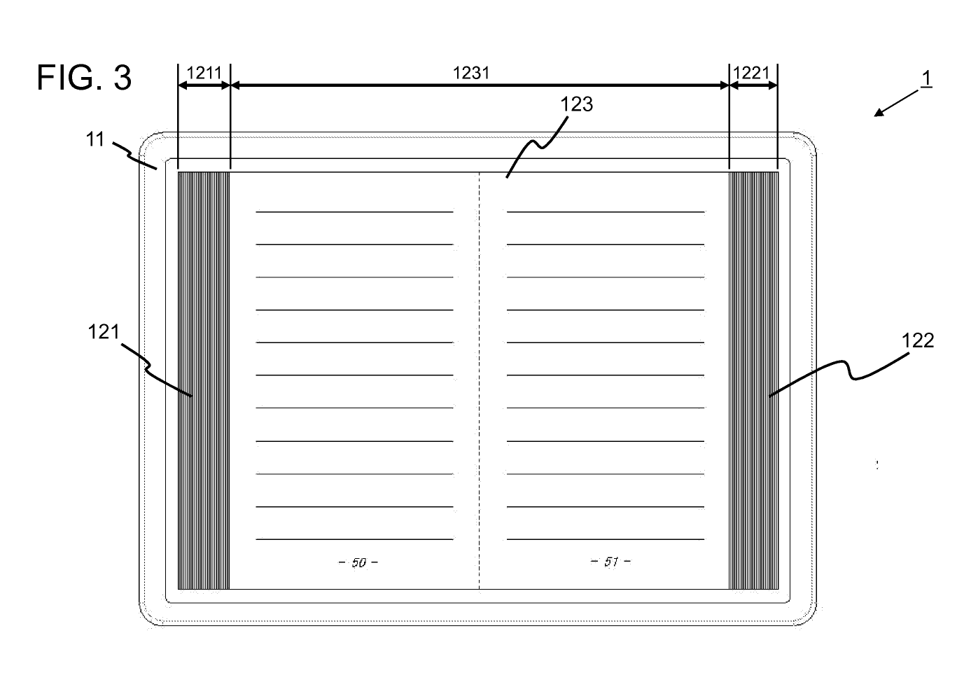

FIG. 3 shows an example of a display screen of the document reader according to the subject exemplary embodiment. Referring to FIG. 3, the electronic document includes a region 123 in which to display the contents of a page(s) selected by the user and regions 121, 122 on its both sides representing the thickness of a plurality of folded sheets or pages. The regions 121, 122 representing the thickness of the folded pages of the document have variable widths 1211, 1221 corresponding to the numbers of the pages from the beginning page and from the last page, respectively. The sum of the widths 1211, 1221 corresponds to the total number of the pages of the electronic document.

If, in the case of an electronic document bound along the left side and that may be opened on the left side, shown for example in FIG. 3, the beginning page is demonstrated in the region 123, the width 1211 of the left side region 121 representing the thickness of folded pages is zero. In a state the last page is represented in the region 123, the width 1221 of the right side region 122 representing the thickness of folded pages is zero. Similarly, if, in the case of an electronic document bound along the right side and that may be opened on the right side, the beginning page is represented in the region 123, the width 1221 of the right side region 122 representing the thickness of folded pages is zero. In a state the last page is represented in the region 123, the width 1211 of the left side region 121 representing the thickness of folded pages is zero. Moreover, if, for example, in the state shown in FIG. 3, the user flicks a portion of the region 123 representing the page contents from the right page side towards the left page side, by way of performing a slide action, the page representing state is switched from the state in which pages 50, 51 are opened to a state in which pages 52, 53 are opened. Moreover, in response to this action, the width 1221 of the right side region 122 indicating the thickness of the right side multiple pages becomes smaller by one page, with the width 1211 of the left side region 121 indicating the thickness of the left side multiple pages becoming wider by one page. On the other hand, the width of the region 123 indicating the page contents remains unchanged, with the region 123 moving itself by one page towards right. Hence, the total width of the regions 121, 122 and 123 remains constant at all times.

Next, the page turn over operation, which may be coped with by the document reader of the subject exemplary embodiment, will be described in detail with reference to the drawings. The document reader 1 of the exemplary embodiment 1 of the present disclosure allows not only the above described page-based page turn over operation, but also the operation of turning over multiple pages either in succession or at a time. In the following, the flow of operations of turning over multiple pages in succession will initially be explained, as a first style page turn over operation, and the flow of operations of turning over multiple pages at a time will then be explained as a second page turn over operation.

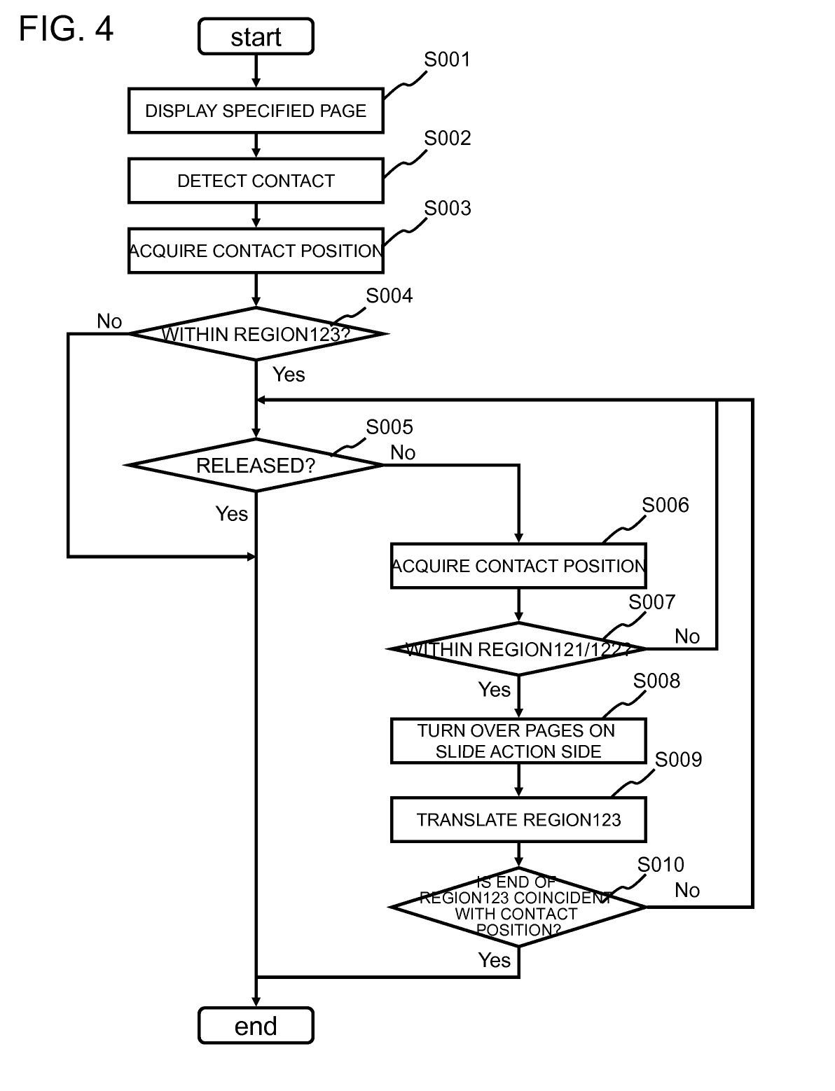

FIG. 4 depicts a flowchart showing the flow of the first style page turn over operation of the document reader 1 according to the exemplary embodiment 1 of the present disclosure. Referring to FIG. 4, a page specified by the user is opened (step S001). If the contact of a user's finger or a utensil, such as a touch pen, on the screen surface, is then detected (step S002), the site of such contact is acquired by the action detection unit 13 (step S003).

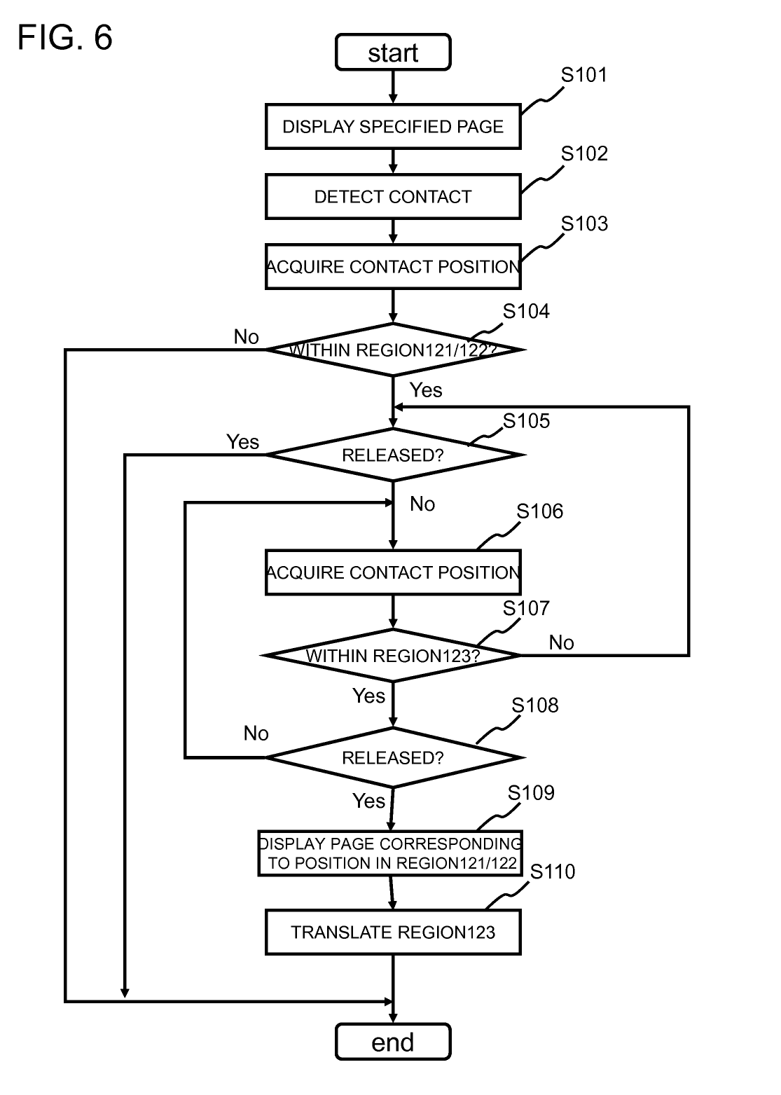

If the contact site acquired is inside the region 123 in which to display the contents of the page(s) selected by the user (Yes of a step S004), the processing which will now be explained is carried out. Note that, if the contact site acquired is outside the region 123 in which to display the contents of the page(s) selected by the user (No of the step S004), processing of the step S104 et seq. of the flowchart of FIG. 6 is carried out.

It is here assumed that the user has done an operation of pointing to an arbitrary position in the region 123 as indicated at 21 in FIG. 5(a). The document reader 1 then checks to see whether or not the user's finger or the utensil such as touch pen has been released from the above mentioned contact position (‘Released?’ of a step S005). If it is detected that the user's finger or the utensil such as touch pen has been released from the screen surface (Yes of the step S005), the first style page turn over operation is discontinued at this moment in time and only the processing as if the position pointed to in the region 123 was simply tapped is carried out.

If the user's finger or the utensil such as touch pen has not been released from the screen surface (No of the step S005), the action detection unit 13 continues to hold the contact position acquired (step S006).

If the contact position acquired has not reached the regions 121, 122 indicating the thickness of folded pages (No of a step S007), the document reader 1 assumes that the flick or slide action by the user is still going on, and hence returns to the step S005.

If the contact position acquired has entered the regions 121 or 122 representing the thickness of folded pages (Yes of the step S007), the document reader 1 performs the operation of turning over a page of either one of the thickness representing regions 121, 122 where the user has performed the flick or slide action (step S008). The document reader 1 also performs an operation of translating the region 123, representing the contents of the page(s) selected by the user, by one page towards the side where the user′ flick action has been performed (step S009).

It is now supposed that the user has pointed to the region 123, representing the contents of the page(s) selected by the user, as shown in FIG. 5(a), and then flicked the selected portion of the region 123 in a direction towards the region 121 representing the thickness of the folded pages. In such case, the document reader 1 continues the processing of turning over left-hand side pages one by one, as shown in FIG. 5(b), and the processing of translating the region 123 towards left.

The document reader 1 then checks to see whether or not the contact position is coincident with an edge of the as-translated region 123 (step S010). If the contact position is not coincident with the edge of the as-translated region 123 (No of the step S010), the document reader 1 returns to the step S005.

If conversely the contact position is coincident with the edge of the as-translated region 123 (Yes of the step S010), the page turn over operation up to the page specified by the user is taken to have come to a close to terminate processing, as shown in FIG. 5(c). Ultimately, the width 1221 of the region 122 becomes wider, and the width 1211 of the region 121 becomes narrower, in an amount corresponding to the number of turned over pages. The region 123 is translated leftwards in a corresponding amount.

As described above, the first style page turn over operation is carried out on the page-by-page basis at a preset speed up to the page corresponding to the position of the region representing the thickness of folded pages 121 contacted by the user. With this first style page turn over operation, it becomes possible to turn over pages by an operation similar to one when the user holding an edge face of the folded pages of a real paper book opened opposite to its bound side shifts his/her finger towards outside little by little by way of turning over multiple pages on the page-by-page basis.

FIG. 6 depicts a flowchart showing the flow of the second style page turn over operation for the document reader 1 according to the exemplary embodiment 1 of the present disclosure. Referring to FIG. 6, if, with the user-specified page opened (step S101), contact of the user's finger or a utensil such as a touch pen on the screen surface is detected (step S102), the contact position is acquired by the action detection unit 13 (step S103).

If the contact position acquired is inside either one of the regions 121, 122 representing the thickness of the folded pages (Yes of a step S104), the processing which will now be explained is carried out. Note that, if the contact position acquired is outside the regions 121, 122 in which to display the thicknesses of the folded page(s) (No of the step S104), the processing is carried out in accordance with the step S004 et seq. of the flowchart of FIG. 4.

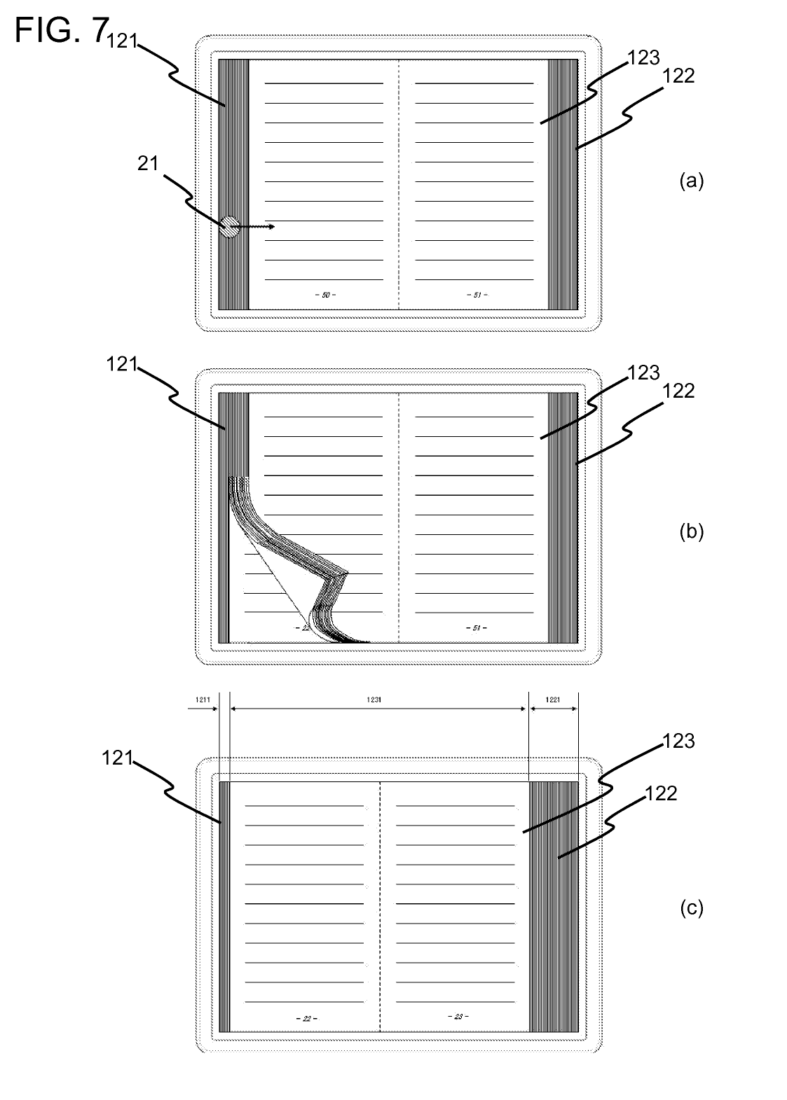

For explanation sake, it is here assumed that an operation of pointing to an arbitrary position of the region 121 representing the thickness of the folded pages has been made as indicated at 21 in FIG. 7(a). The document reader 1 then checks to see whether or not the user's finger or the utensil such as touch pen has been released from the contact position (‘Released?’ in a step S105). If it is detected that the user's finger or the utensil such as touch pen has been released from the contact position (Yes of the step S105), the second style page turn over operation is discontinued at this moment in time and only processing as a tap operation at the position of the region 121 or 122 pointed to is carried out.

If the user's finger or the utensil such as touch pen has not been released from the screen surface (No of the step S105), the action detection unit 13 continues to hold the contact position acquired (step S106).

If the contact position acquired has not reached the region 123 representing the contents of the page selected by the user (No of a step S107), the document reader 1 assumes that the flick action by the user is still going on, and accordingly returns to the step S105.

If the contact site acquired as described above has entered the region 123 in which to display the contents of the page(s) selected by the user (Yes of the step S107), the document reader 1 checks to see whether or not the user's finger or the utensil such as touch pen has been released from the screen surface (‘Released?’ of a step S108). If the user's finger or the utensil such as the touch pen has not been released from the screen surface (No of the step S108), the action detection unit 13 continues to hold the contact position acquired (step S106).

If it is detected in the step S108 that the user's finger or the utensil such as the touch pen has been released from the screen surface (Yes of the step S108), the document reader 1 performs processing of turning over multiple pages in a lump (step S109). This lumped page turn over operation is continued up to the page corresponding to the contact position in the thickness representing region 121 or 122 as detected in the step S103 (beginning point of the flick or slide action) as shown in FIG. 7(a) and FIG. 7(b). The document reader 1 performs processing of translating the region 123, representing the contents of the page(s) selected by the user, in a direction towards whichever one of the regions 121 and 122 where the user's flick movement originated, in an amount corresponding to the number of the pages turned over by the lumped page turn over operation (step S110).

For example, it is now assumed that the user has first pointed to the thickness representing region 121 and then has made a flick or slide action towards the region 123 representing the contents of the page(s) selected by the user, as shown in FIG. 7(a). In this case, the document reader 1 performs the processing of turning over multiple pages in a lump, until reaching the page of the position of the thickness representing region 121 specified by the user, and the processing of translating the region 123 towards left, as shown in FIG. 7(b) and FIG. 7(c). As a result, the width 1221 of the region 122 becomes wider and the width 1211 of the region 121 narrower, with the region 123 shifting towards left, in an amount related to the number of the turned over pages.

According to the second style page turn over operation, described above, it is possible to turn over pages by processing similar to the customary operation of collectively turning over many pages of a paper book at a time as the user inserts his/her index finger between pages on an end face of the paper book opened.

### Exemplary Embodiment 2

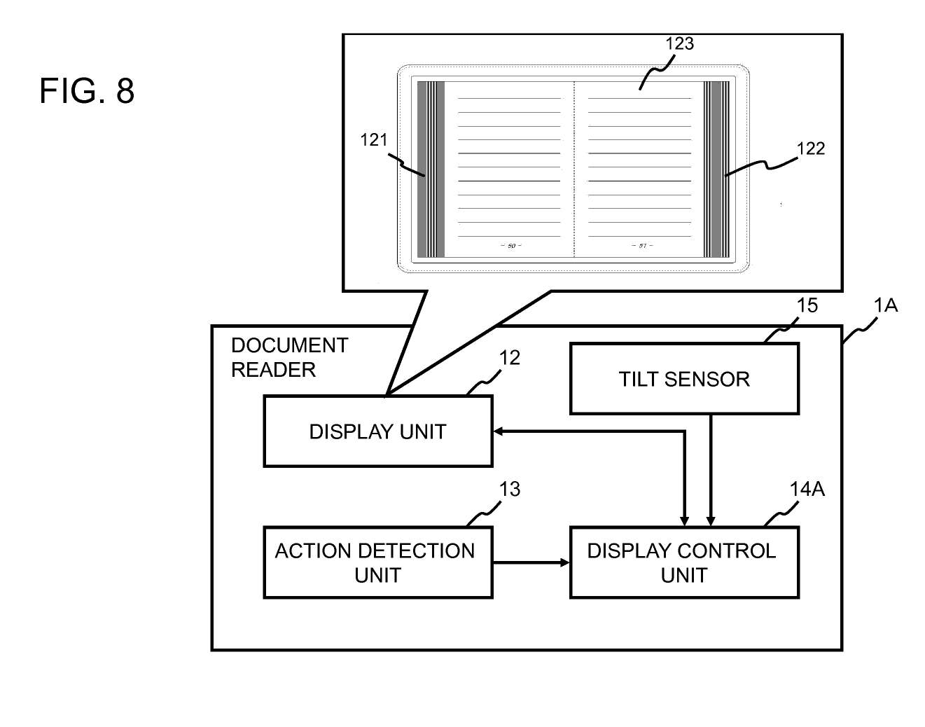

An exemplary embodiment 2 in which an operation of tilting a housing is used in place of the slide action of the above described exemplary embodiment 1 will now be described. FIG. 8 depicts a functional block diagram of the document reader, partly shown in a front view, according to an exemplary embodiment 2 of the present disclosure. The configuration of the subject exemplary embodiment differs from that of the exemplary embodiment 1 in including a tilt sensor 15 as an additional component. Otherwise, the configuration of the subject exemplary embodiment is similar to that of the exemplary embodiment 1, and hence the following description of the subject exemplary embodiment is centered on this point of difference.

The tilt sensor 15 is a sensor configured for detecting the tilt of the housing 11 of a document reader 1A.

The display control unit 14 performs a page turn over operation using not only an output of the action detection unit 13 but also the tilt of the housing 11 acquired by the tilt sensor 15.

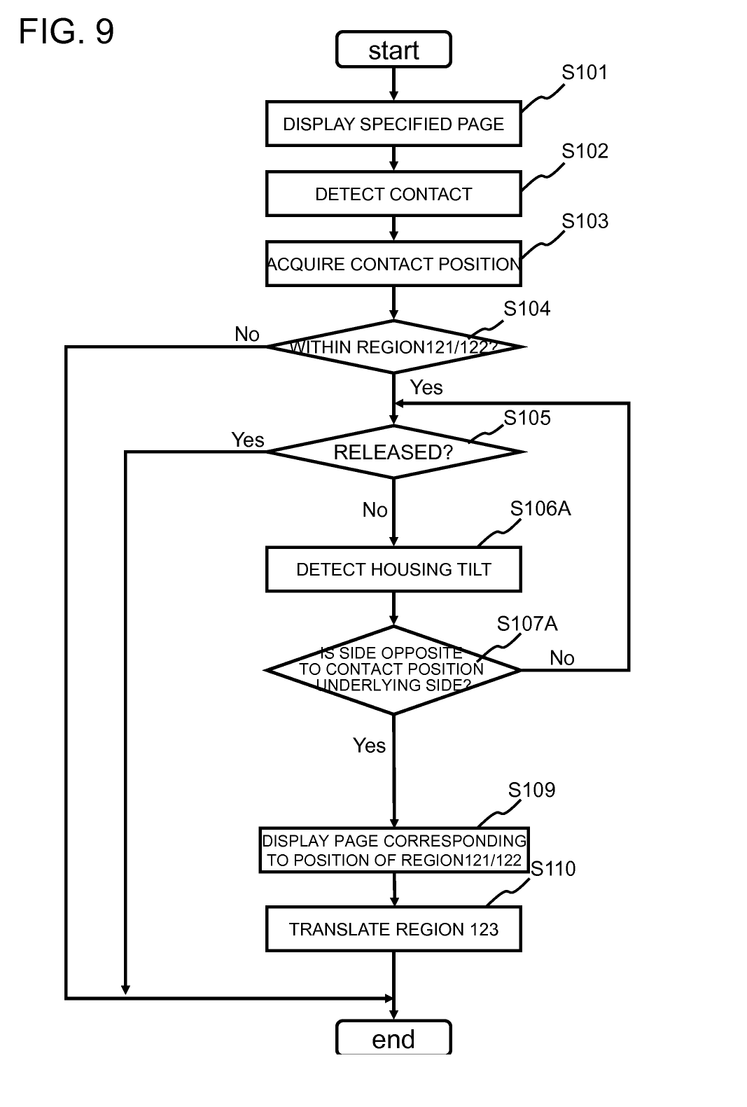

The page turn over operation, coped with by the document reader of the subject exemplary embodiment, will now be explained in detail with reference to the drawings. FIG. 9 depicts a flowchart showing the flow of the page turn over operation according to the subject exemplary embodiment 2 in which the tilt of the housing of the document reader 1A is used as an instruction from a user. Referring to FIG. 9, a page specified by the user is opened (step S101). If the contact of a user's finger or a utensil, such as touch pen, on the screen surface, is then detected (step S102), the position of such contact is acquired by the action detection unit 13 (step S103).

If the contact position acquired is either one of the thickness representing regions 121 and 122 (Yes of a step S104), the operation which will now be explained is carried out. Note that, if the contact position acquired is outside the region 121 or 122 in which to display the thickness of the folded pages as selected by the user (No of the step S004), the step S004 et seq. of the flowchart of FIG. 4, explained in connection with the exemplary embodiment 1, is carried out.

It is now assumed that an action of pointing to an arbitrary position in the thickness representing region 121 has been made, as indicated at 21 of FIG. 7(a). The document reader 1A then checks to see whether or not the user's finger or the utensil, such as touch pen, has moved away from the contact position (‘Released? in a step S105). If it has been detected that the user's finger or the utensil, such as touch pen, has moved away from the screen surface (Yes of the step S105), the page turn over operation is discontinued at that moment in time and only processing as a tap operation at the position of the region 121 or 122 pointed to is carried out.

If conversely the user's finger or the utensil, such as touch pen, has not moved away from the screen surface (No of the step 105), only acquisition of the information concerning the tilt of the housing 11 by the tilt sensor 15 is continued (step S106A).

If the tilt of the housing such that an edge thereof opposite to its edge touched by the user's finger or the touch pen underlies the edge touched has not been detected by the tilt sensor 15 (No of a step 107A), the document reader 1A assumes that the explicit page turn over action by a user is not going on, and returns to the step S105.

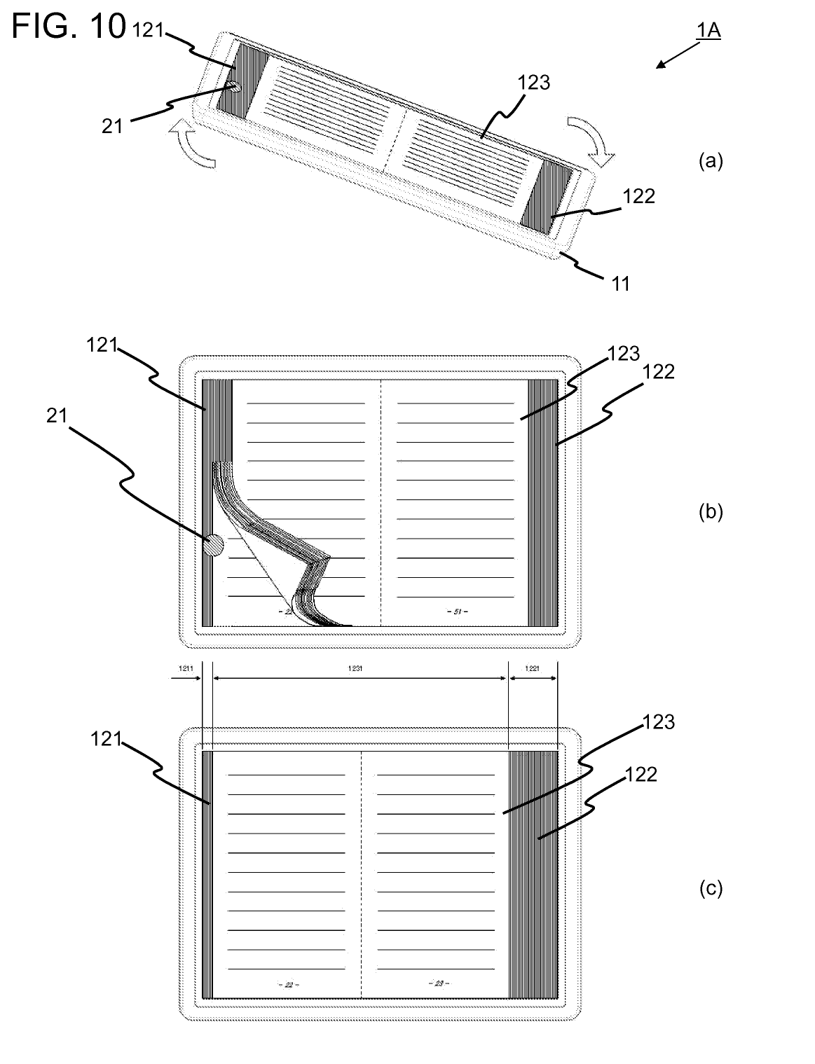

If conversely the tilt of the housing such that the edge thereof opposite to its edge touched by the user's finger or the touch pen underlies the edge touched has been detected (Yes of the step 107A), the document reader 1A performs a lumped page turn over operation of turning over multiple pages in a lump, until reaching a page corresponding to the position within the region 121 or 122 as detected in the step S103, as shown in FIGS. 10(b) and 10(c) (step S109). This position is the beginning point of the slide action. The document reader 1A also performs the processing of translating the region 123, representing the contents of the page(s) selected by the user, in an amount corresponding to the number of the turned over pages, in a direction towards the region 121 or 122 from which originated the slide action (step S110).

For example, it is assumed that an operation has been made of pointing to the thickness representing region 121 and raising the edge of the housing disposed towards the region 121 while lowering its opposite side edge disposed towards the region 122, as shown in FIG. 10(a). In this case, the document reader 1A performs the operation of collectively turning over multiple pages of the thickness representing region 121, as instructed by the user, and the operation of translating the region 123 towards left, as shown in FIG. 10(b) and FIG. 10(c). As a result, the width 1221 of the region 122 becomes broader, and the width 1211 of the region 121 narrower, in an amount corresponding to the number of the turned over pages. The region 123 is also correspondingly translated towards left.

In the subject exemplary embodiment, described above, it is possible to turn over pages by an operation of pointing to a desired page in the thickness representing region 121 and tilting the housing 11. This operation is tantamount to an operation of a user inserting his/her finger between folded pages on an edge face of a real paper book opened and tilting the book to turn over multiple pages at a time.

As may be seen from the above described exemplary embodiments 1 and 2 of the present disclosure, the operation in reading the electronic document, in particular, the operation in turning over its many pages, may be simplified. Moreover, it may be seen from the widths of the thickness representing regions 121, 122 which position in the entire electronic document is assumed by the page(s) currently represented.

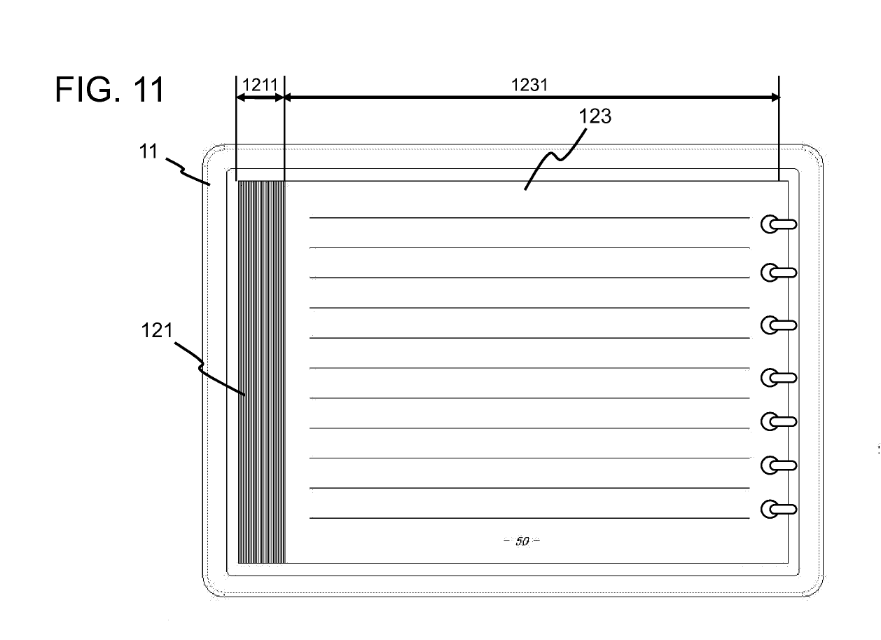

Although certain preferred exemplary embodiments of the present invention are shown and described above, the present invention is not to be restricted to these particular modes, such that further changes, substitutions or adjustments may be made within the range not departing from the basic technical concept of the invention. For example, in the above described exemplary embodiments, the electronic document is displayed with its two pages opened. However, such page display configuration in which the thickness representing region 121 is provided only on one side, as shown in FIG. 11, may also be used to enable a similar operation to be performed. It should be noted that, in this case, a page returning processing cannot be accomplished with the first and second styles of the page turn over operation. However, it is then only sufficient that prescription for a page returning operation is separately provided, or a page recycle electronic document configuration is used in which a first page is displayed on turning over the last page.

Though not shown or described in the above exemplary embodiments, it is also possible to provide a device for setting up oscillations, such as a vibrator, in the document reader. If such device for setting up oscillations is provided and used for setting up oscillations when performing the page turn over operation, a user may perceive that the page is being turned over by dint of his/her tactile sense.

In the above described exemplary embodiment 1, there is made no reference to the speed of the slide movement. It is however possible to change the speed of the page turn over operation in relation to the speed of the slide movement.

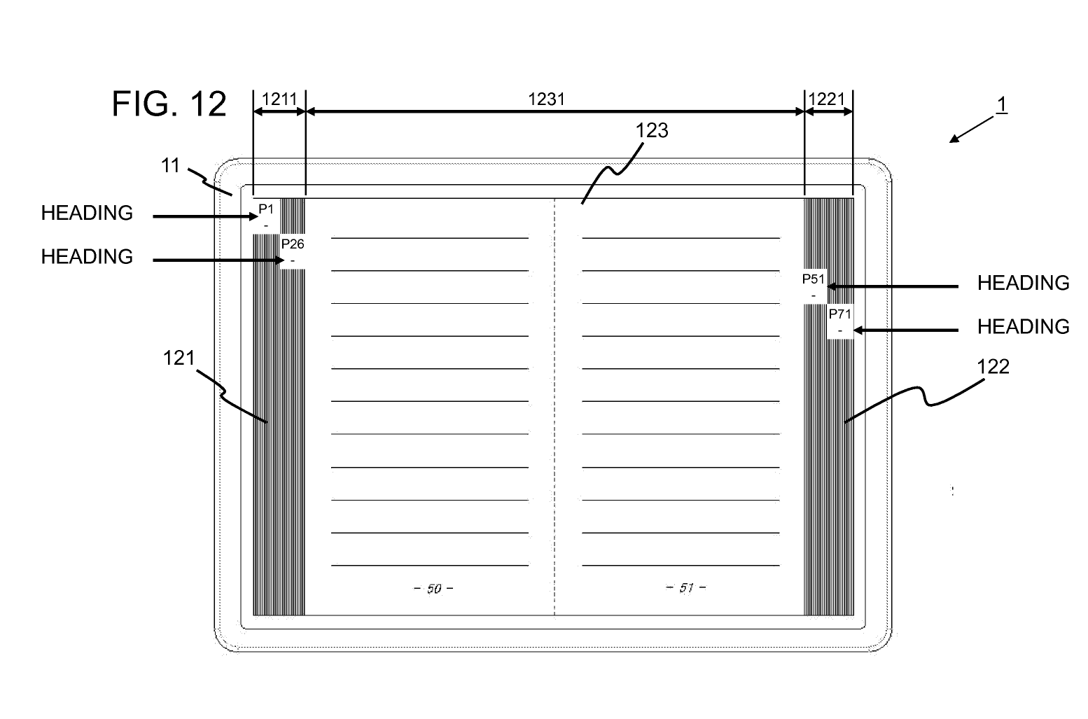

The thickness representing regions 121, 122 can be marked with colors that are changed from one group of consecutive pages to another, or headers and so on can be inserted for every preset number of consecutive pages, as shown in FIG. 12. By so doing, it is possible to assure facilitated selection of a plurality of pages or to enhance ease in reading the document.

In the above described exemplary embodiments, the present invention is applied to a terminal of a tablet configuration provided with a touch panel. However, the present invention may be applied to a personal computer, a book reader terminal or a game machine of the position fixed configuration. In this case, a touch sensor may be used as in the above described exemplary embodiments. However, a pointing device, such as a tablet device, a mouse or a cross-key, and a button, may also be used, and selection of the regions 121, 122 representing the thickness of folded pages or the region 123 demonstrating the page contents may be coped with by a dragging action equivalent to the above mentioned slide action. A tilt sensor or an acceleration sensor, mounted onboard a controller of the tablet device, mouse or the game machine, may also be used as the tilt sensor.

The disclosures of the above mentioned Patent literatures are to be incorporated herein by reference. The exemplary embodiments or examples may be modified or adjusted within the concept of the total disclosures of the present invention, inclusive of claims, based on the fundamental technical concept of the invention. A wide variety of combinations or selections of elements herein disclosed (elements of claims, exemplary embodiments, examples and drawings) may be made within the context of the claims of the present invention. That is, the present invention may include a wide variety of changes or corrections that may occur to those skilled in the art in accordance with the total disclosures inclusive of the claims and the drawings as well as the technical concept of the invention. In particular, it should be understood that any optional numerical figures or sub-ranges contained in the ranges of numerical values set out herein ought to be construed to be specifically stated even in the absence of explicit statements.

### EXPLANATION OF SYMBOLS

1, 1A document readers
11 housing
12 display unit
13 action detection unit
14 display control unit
15 tilt sensor
21 position specified by a user
121, 122 regions representing the thickness of folded pages
123 region representing page contents
1211, 1221, 1231 widths

What is claimed is:

1. A document reader comprising:
a display unit that demonstrates a region representing contents of a page selected by a user of an electronic document of a style composed by a plurality of pages held together, and a region which is provided neighboring to the region representing the page contents and which represents the thickness of the plurality of the pages held together;
an action detection unit that detects contents of an action on the electronic document performed by specifying an arbitrary point in each of the regions; and
a display control unit that performs, in case an action of specifying two points, namely an arbitrary position in the region representing the page contents and an arbitrary position in the region representing the thickness of the plurality of the pages held together, is carried out by a user so that the two points are specified in succession, a processing of turning over multiple pages up to a page corresponding to the position specified in the region representing the thickness of the plurality of the pages held together.

2. The document reader according to claim 1, wherein,
the display control unit causes a width of the region representing the thickness of the plurality of folded pages to be changed each time a page is turned over.

3. The document reader according to claim 1, wherein,
in case the display control unit specifies the arbitrary position in the region representing the page contents and subsequently specifies the arbitrary position in the region representing the thickness of the plurality of folded pages, the display control unit performs processing of turning over multiple pages in sequence from a page currently demonstrated to a page corresponding to the specified position in the region representing the thickness of the plurality of folded pages.

4. The document reader according to claim 1, wherein,
in case the display control unit specifies the arbitrary position in the region representing the thickness of the plurality of folded pages and subsequently specifies the region representing the contents of the page, the display control unit performs processing of collectively turning over multiple pages at a time up to a page corresponding to the specified position in the region representing the thickness of the plurality of the folded pages.

5. The document reader according to claim 1, wherein,
the action detection unit is constituted by a touch sensor; and wherein,
the two points specified by the user are detected by a start point and an end point of a slide action on the screen surface representing document data of a style composed by the plurality of folded pages held together.

6. The document reader according to claim 1, further comprising:
a sensor that detects an operation of tilting the electronic document represented by the display unit; wherein,
the display control unit performs, in case an operation of specifying the arbitrary position of the region representing the thickness of the plurality of the pages held together and an operation of tilting the electronic document so that the region representing the thickness of the plurality of the pages held together will overlie the region representing the page contents, are performed, a processing of turning over multiple pages at a time up to the specified position in the region representing the thickness of the plurality of the pages held together,
in place of performing, in case the action of specifying the two points, namely the arbitrary position in the region representing the page contents and the arbitrary position in the region representing the thickness of the plurality of the pages held together, is carried out by a user so that the two points are specified in succession, the operation of turning over multiple pages up to a page corresponding to the position specified in the region representing the thickness of the plurality of the pages held together.

7. The document reader according to claim 1, wherein,
the region representing the thickness of the plurality of the pages held together is differently colored or marked from one set of consecutive pages to another.

8. A method for turning over multiple pages of an electronic document of a style composed by a plurality of pages held together, in a document reader including display unit for displaying a region representing contents of a page selected by a user and a region which is provided neighboring to the region representing the page contents and which represents the thickness of the plurality of the pages held together; the method comprising:
detecting contents of actions performed on the electronic document by specifying an arbitrary point in each of the regions; and
performing, in case an action of specifying two points, namely an arbitrary position in the region representing the page contents and an arbitrary position in the region representing the thickness of the plurality of the pages held together, is carried out by a user so that the two points are specified in succession, a processing of turning over multiple pages up to a page corresponding to the position specified in the region representing the thickness of the plurality of the pages held together.

9. A non-transitory computer-readable recording medium storing thereon a program for causing a computer provided onboard a document reader including display unit that displays a region representing contents of a page selected by a user of an electronic document of a style composed by a plurality of pages held together and a region which is provided neighboring to the region representing the page contents and which represents the thickness of the plurality of the pages held together, to perform a processing for:
detecting contents of an action performed on the electronic document by specifying an arbitrary position in each of the regions; and
performing, in case an action of specifying two points, namely an arbitrary position in the region representing the page contents and an arbitrary position in the region representing the thickness of the plurality of the pages held together, is carried out by a user so that the two points are specified in succession, a processing of turning over multiple pages up to a page corresponding to the position specified in the region representing the thickness of the plurality of the pages held together.

10. The document reader according to claim 2, wherein,
in case the display control unit specifies the arbitrary position in the region representing the page contents and subsequently specifies the arbitrary position in the region representing the thickness of the plurality of folded pages, the display control unit performs processing of turning over multiple pages in sequence from a page currently demonstrated to a page corresponding to the specified position in the region representing the thickness of the plurality of folded pages.

11. The document reader according to claim 2, wherein,
in case the display control unit specifies the arbitrary position in the region representing the thickness of the plurality of folded pages and subsequently specifies the region representing the contents of the page, the display control unit performs processing of collectively turning over multiple pages at a time up to a page corresponding to the specified position in the region representing the thickness of the plurality of the folded pages.

12. The document reader according to claim 3, wherein,
in case the display control unit specifies the arbitrary position in the region representing the thickness of the plurality of folded pages and subsequently specifies the region representing the contents of the page, the display control unit performs processing of collectively turning over multiple pages at a time up to a page corresponding to the specified position in the region representing the thickness of the plurality of the folded pages.

13. The document reader according to claim 2, wherein,
the action detection unit is constituted by a touch sensor; and wherein,
the two points specified by the user are detected by a start point and an end point of a slide action on the screen surface representing document data of a style composed by the plurality of folded pages held together.

14. The document reader according to claim 3, wherein,
the action detection unit is constituted by a touch sensor; and wherein,
the two points specified by the user are detected by a start point and an end point of a slide action on the screen surface representing document data of a style composed by the plurality of folded pages held together.

15. The document reader according to claim 4, wherein,
the action detection unit is constituted by a touch sensor; and wherein,
the two points specified by the user are detected by a start point and an end point of a slide action on the screen surface representing document data of a style composed by the plurality of folded pages held together.

16. The document reader according to claim 2, further comprising:
a sensor that detects an operation of tilting the electronic document represented by the display unit; wherein,
the display control unit performs, in case an operation of specifying the arbitrary position of the region representing the thickness of the plurality of the pages held together and an operation of tilting the electronic document so that the region representing the thickness of the plurality of the pages held together will overlie the region representing the page contents, are performed, a processing of turning over multiple pages at a time up to the specified position in the region representing the thickness of the plurality of the pages held together,
in place of performing, in case the action of specifying the two points, namely the arbitrary position in the region representing the page contents and the arbitrary position in the region representing the thickness of the plurality of the pages held together, is carried out by a user so that the two points are specified in succession, the operation of turning over multiple pages up to a page corresponding to the position specified in the region representing the thickness of the plurality of the pages held together.

17. The document reader according to claim 3, further comprising:
a sensor that detects an operation of tilting the electronic document represented by the display unit; wherein,
the display control unit performs, in case an operation of specifying the arbitrary position of the region representing the thickness of the plurality of the pages held together and an operation of tilting the electronic document so that the region representing the thickness of the plurality of the pages held together will overlie the region representing the page contents, are performed, a processing of turning over multiple pages at a time up to the specified position in the region representing the thickness of the plurality of the pages held together,
in place of performing, in case the action of specifying the two points, namely the arbitrary position in the region representing the page contents and the arbitrary position in the region representing the thickness of the plurality of the pages held together, is carried out by a user so that the two points are specified in succession, the operation of turning over multiple pages up to a page corresponding to the position specified in the region representing the thickness of the plurality of the pages held together.

18. The document reader according to claim 4, further comprising:
a sensor that detects an operation of tilting the electronic document represented by the display unit; wherein,
the display control unit performs, in case an operation of specifying the arbitrary position of the region representing the thickness of the plurality of the pages held together and an operation of tilting the electronic document so that the region representing the thickness of the plurality of the pages held together will overlie the region representing the page contents, are performed, a processing of turning over multiple pages at a time up to the specified position in the region representing the thickness of the plurality of the pages held together,
in place of performing, in case the action of specifying the two points, namely the arbitrary position in the region representing the page contents and the arbitrary position in the region representing the thickness of the plurality of the pages held together, is carried out by a user so that the two points are specified in succession, the operation of turning over multiple pages up to a page corresponding to the position specified in the region representing the thickness of the plurality of the pages held together.

19. The document reader according to claim 5, further comprising:
a sensor that detects an operation of tilting the electronic document represented by the display unit; wherein,
the display control unit performs, in case an operation of specifying the arbitrary position of the region representing the thickness of the plurality of the pages held together and an operation of tilting the electronic document so that the region representing the thickness of the plurality of the pages held together will overlie the region representing the page contents, are performed, a processing of turning over multiple pages at a time up to the specified position in the region representing the thickness of the plurality of the pages held together,
in place of performing, in case the action of specifying the two points, namely the arbitrary position in the region representing the page contents and the arbitrary position in the region representing the thickness of the plurality of the pages held together, is carried out by a user so that the two points are specified in succession, the operation of turning over multiple pages up to a page corresponding to the position specified in the region representing the thickness of the plurality of the pages held together.
